(19) United States
(12) Patent Application Publication
(10) Pub. No.: US 2014/0009141 A1
(43) Pub. Date: Jan. 9, 2014

(54) Method for Operating a Speed Sensing Device

(71) Applicant: Robert Bosch GmbH, Stuttgart (DE)

(72) Inventors: Jacek Wiszniewski, Leinfelden-Echterdingen (DE); Kamil Pogorzeiski, Stuttgart (DE)

(21) Appl. No.: 13/933,509

(22) Filed: Jul. 2, 2013

(30) Foreign Application Priority Data
Jul. 3, 2012 (DE) 10 2012 211 561.7

(51) Int. Cl. G01P 3/487

(52) U.S. Cl. CPC G01P 3/487
USPC 324/174

(57) ABSTRACT

The disclosure describes a method for operating a speed sensing device including a magnetically operating speed encoder that is located on a rotatably mounted shaft and a fixed sensor configured to interact with the speed encoder. The speed encoder includes at least one encoder element configured to move past the fixed sensor upon a revolution of the shaft and thereby produces an electrical pulse. The sensing of the electrical pulses produced determines the speed of the shaft. For at least a plurality of successive electrical pulses, the respective time of a signal period for at least two successive electrical pulses is measured and stored, and the respective time of at least one selected test period for the signal periods is compared with (i) the time of the previous signal period, and (ii) with the time of the subsequent signal period in order to detect absent and/or incorrect electrical pulses.

This application claims priority under 35 U.S.C. §119 to patent application no. DE 10 2012 211 561.7, filed on Jul. 3, 2012 in Germany, the disclosure of which is incorporated herein by reference in its entirety.

### BACKGROUND

The disclosure relates to a method for operating a speed sensing device that has a speed encoder that is arranged on a rotatably mounted shaft and a fixed sensor interacting with the speed encoder, wherein the speed encoder has at least one encoder element that moves past the sensor upon a revolution of the shaft and thereby produces an electrical pulse, wherein sensing of the pulses produced determines the speed of the shaft.

Speed sensing devices of the type cited at the outset are known from the prior art. Particularly in the automotive industry, speed sensing devices are frequently used. By way of example, they are used for safety systems such as antilock braking systems or stabilization systems in order to sense the speeds of the wheels on the motor vehicle, as a result of which the sensed speeds can be taken as a basis for actuating the safety systems as appropriate. On the basis of the sensed pulses, which are correlated to time, it is a simple matter to determine the speed of the shaft, for example for an electrical machine or a wheel on the motor vehicle. In the case of speed encoders that operate magnetically and in this respect are designed as magnetized magnet wheels, for example, unbalanced magnetization can result in incorrect or absent pulses which lead to an imprecise speed indication.

### SUMMARY

The inventive method for operating the speed sensing device has the advantage that sporadically occurring disturbances during operation of the speed sensing device can be sensed and evaluated and, by way of example, unbalanced magnetizations in speed encoders can be compensated for. Furthermore, the inventive method can be used to safely determine the speed even at low rates of rotation, even if the, in particular magnetically operating, speed encoder has unbalanced magnetization.

The inventive method is distinguished in that, for at least a plurality of successive pulses, the respective time of a signal period for at least two successive pulses is measured and stored, and in that the respective time of a chosen test period for the signal periods is compared with the time of the previous signal period and/or with the time of the subsequent signal period in order to detect absent or incorrect pulses. Thus, for a plurality of successive pulses, the respective signal period associated with the pulse or the time from the beginning of the pulse to the beginning of the following pulse is measured and stored. With particular preference, all successive pulses are measured during operation and are stored at least for a minimum time that is necessary for determining absent or incorrect pulses. The comparison and successive signal periods therefore allows recognition of whether the sensed pulses are incorrect, that is to say unwanted additional, pulses or whether expected pulses are absent. In this case, successive signal periods are compared with one another, one of which is denoted as a test period. Preferably, the method is carried out in such continuous fashion that each of the signal periods forms the test period at one time.

According to one advantageous development of the disclosure, an absent pulse is sensed when the time of the test period is greater than the times of the previous and subsequent signal periods. Particularly if the test period is twice as long as the adjacent signal periods, it is a simple matter to infer that a pulse is absent.

According to one advantageous development of the disclosure, an absent pulse is sensed when the time of the test period is less than the time of the previous or subsequent signal period. If there is an incorrect, that is to say unexpected additional, pulse present then this shortens the otherwise existing signal period between two envisaged pulses. A comparison with one of the adjacent or with both adjacent signal periods therefore makes it a simple matter to infer an incorrect pulse.

With particular preference, the incorrect pulse is detected when the time of the test period is at least half as short as the time of the previous or subsequent signal period.

According to one advantageous development of the disclosure, the pulse width of at least the plurality of sensed pulses is respectively measured and stored. The pulse width of the pulses can likewise be used to determine absent or incorrect pulses, which optimizes the inventive method further.

With particular preference, an absent pulse is deactivated on the basis of the average width of the sensed pulses. Preferably, the average width of the sensed pulses is determined and compared with one another. If the width of a pulse turns out to be relatively small, for example, said pulse is detected as an absent pulse.

In addition or alternatively, an incorrect pulse is sensed when the width of a sensed pulse is within a prescribable period of time. Preferably, the period of time is chosen to be short enough for a pulse width that is situated in said period of time completely to indicate an incorrect or unwanted pulse. This makes it a simple matter to safely recognize absent and incorrect pulses on the basis of the pulse widths and the pulse gaps and to take them into account as appropriate when determining the speed.

Particularly in the case of unbalanced magnetized magnet wheels that act as speed encoders, taking into account the respective pulse width means an increase in certainty when determining the speed.

The inventive speed sensing apparatus having the features of claim 8 is distinguished by a control unit that carries out the method described above. To this end, the control unit preferably has a memory and also a microprocessor, the method being able to be carried out by means of the microprocessor and the ascertained data being able to be stored in the memory.

### BRIEF DESCRIPTION OF THE DRAWINGS

The disclosure will be explained in more detail below with reference to the drawings, in which:

FIG. 1 shows a simplified illustration of a speed sensing device,

FIG. 2 shows electrical pulses produced by the speed sensing device,

FIG. 3 shows an exemplary embodiment for sensing an incorrect pulse,

FIG. 4 shows an exemplary embodiment for sensing an absent pulse gap, and

FIG. 5 shows an exemplary embodiment for sensing an additional pulse gap within a pulse.

### DETAILED DESCRIPTION

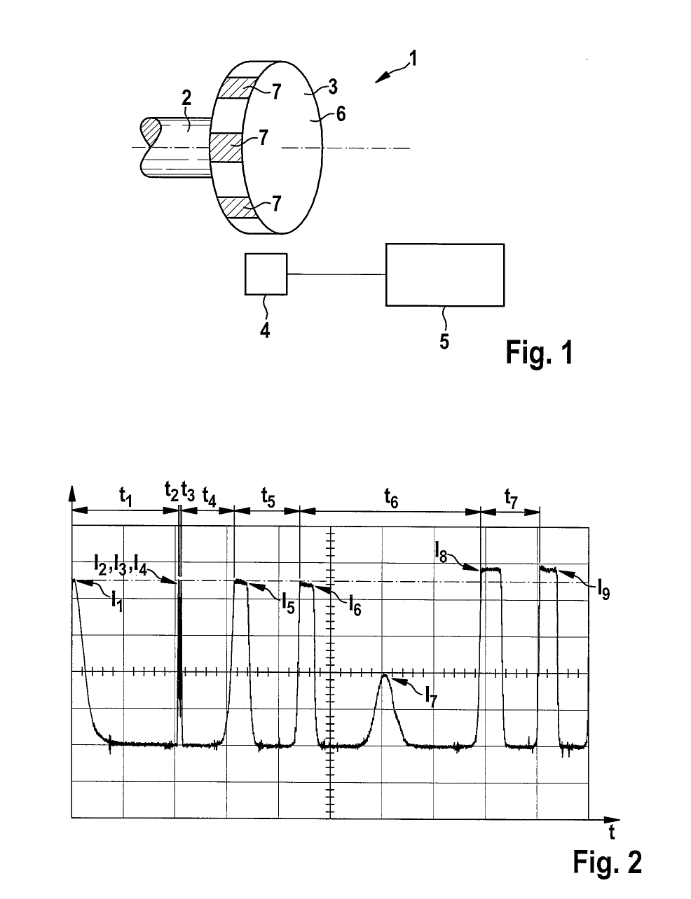

FIG. 1 shows a simplified illustration of a speed sensing device 1 that has a speed encoder 3 arranged on a rotatably mounted shaft such that they rotate together and also a fixed sensor 4 and a control unit 5 that is connected to the sensor. The speed encoder 3 is in the form of a magnetic wheel 6, the outer circumference of which is provided with a plurality of encoder elements 7 that preferably protrude radially, so that the magnet wheel 6 ultimately forms an encoder gearwheel. The sensor 4 is designed to sense the magnetic fields from the encoder elements. The magnetic fields produce a respective electrical pulse in the sensor 4 that is sensed and stored by the control unit 5. From the pulse sensed within a particular time, it is a simple matter to determine the speed of the shaft 2.

Furthermore, the control unit 5 measures, for at least a plurality of successive pulses, the respective time of a signal period for at least two successive pulses and stores said time. The time of a test period for the signal periods is then compared with the time of the signal period for a previous pulse and/or with the time of a subsequent signal period in order to sense absent and/or incorrect pulses.

In this regard, FIG. 2 shows a graph illustrating the electrical pulses produced by means of the sensor 4 over time t with the aid of an exemplary instance of application. In this exemplary embodiment, the control unit 5 senses nine pulses I₁-I₉ and the periods of time t₁ to t₇ situated between the pulses I₁-I₉, and stores these.

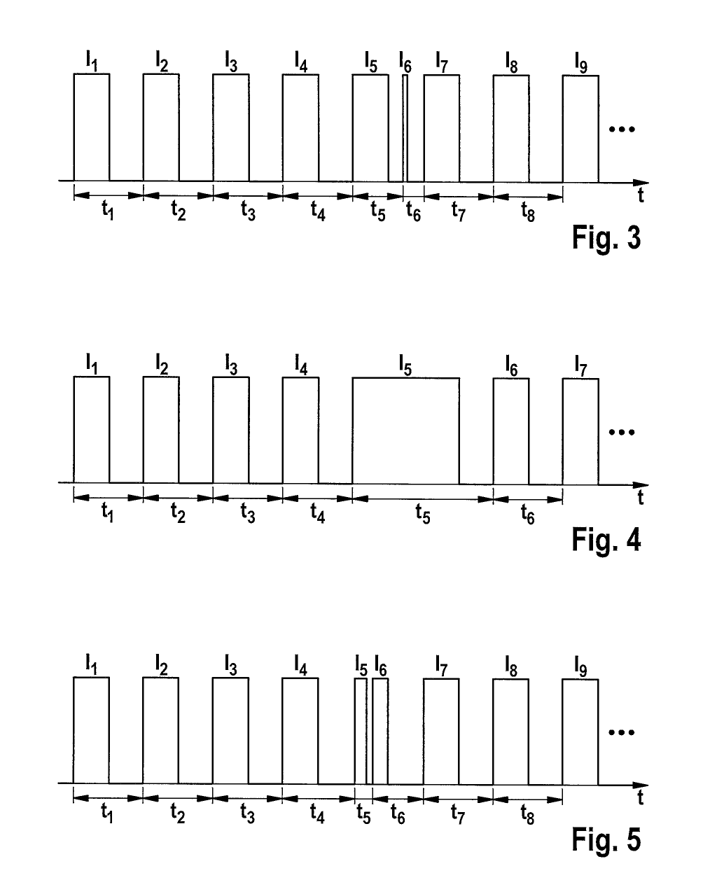

The control unit detects an absent pulse when the time of a chosen test period is distinctly greater than the times of the previous and subsequent signal periods. Since the width of the pulses I₁ to I₉ should remain constant for a steady rate of rotation, the sensed pulse additionally allow confirmation that an absent pulse is involved when said pulse—as shown in FIG. 2 for pulse I₇, for example—is shorter than the adjacent pulses I₆, I₈, or in FIG. 3 for pulse I₆.

This information can also be used for magnet wheels with unbalanced magnetization, since the width of the absent pulses is distinctly smaller. The control unit preferably ascertains the average width of the pulses I₁-I₉ for a predetermined number of revolutions or rate of revolution and detects the absent pulse when the width of a pulse from the test period turns out to be distinctly less than the average width.

In order to detect incorrect pulses that occur on account of disturbances, the control unit 5 compares the period of time for the test period to determine whether it is less or shorter than the time of the previous or subsequent signal period. In particular, the incorrect pulse is recognized when the time between the previous and subsequent pulses is at least half as short. To this end, the control unit 5 senses whether the time of the chosen test period is less than the time of the previous and subsequent signal periods. Advantageously, a check is performed to determine whether time between the incorrect pulse and the previous pulse is at least half as short as the time between the incorrect pulse and the subsequent pulse. For a steady rate of rotation, the time between previous and subsequent pulses is the same on account of the even distribution of the encoder elements 7 over the circumference of the magnet wheel 6. Therefore, it is a simple matter to sense a shortened period of time or signal period and thereby to ascertain an incorrect pulse. Advantageously, this also takes into account the, in particular average, width of the pulses I₁-I₉ in order to confirm that an incorrect pulse is actually involved. To this end, the pulse width of the pulse that is considered to be incorrect is compared with a prescribed period of time. The incorrect pulse is then confirmed if its width is less than the prescribable period of time. The period of time is preferably chosen such that it is less than the expected width of the pulses I₁-I₉ that should actually be produced by the encoder elements 7. This information can also be used for magnet wheels with unbalanced magnetization, since the width of the incorrect pulses is accordingly distinctly smaller. In this case, the average width of the pulses is sensed for a particular number of revolutions or rate of revolution and an incorrect pulse is detected if said width is below a limit threshold or the prescribable period of time. The method is carried out such that each signal period is used as a test period at least once and is compared with the previous and/or subsequent signal period as described above.

At low speeds, any imbalance in the magnet wheels that may be present has a relatively great influence. This results in the worst magnetized encoder element 7 not being recognized by a taco system for determining the speed of a motor vehicle, for example. This results in absent pulses, which are recognized by means of the method described above, however. Therefore, absent and also incorrect pulses can be taken into account for determining the speed of the shaft 2 and the speed can be correctly measured or determined. FIG. 2 shows both an incorrect pulse I₂ that has arisen as a result of disturbances and an absent or unrecognized pulse I₇. As described above, these are sensed by sensing the average pulse width and the, in particular average, time of the pulse gaps. The method described therefore allows absent or incorrect pulses from a signal encoder or speed encoder to be recognized on the basis of time differences owing to sporadic disturbances or imbalance, for example, for example on account of unbalanced magnetization.

FIGS. 3, 4 and 5 show further instances of application of the described method for sensing incorrect pulses. They each show the electrical pulses sensed by the sensor 4 over time t, with FIG. 3 involving an incorrect or additional pulse I₆ being sensed, FIG. 4 involving an absent pulse gap or an excessively wide pulse I₅, and FIG. 5 involving an additional pulse gap within a pulse.

In the case of a pulse pattern as shown in FIG. 3, application of the above method ascertains that the signal period t₆ is less than the adjacent signal periods t₅ and t₇. If, furthermore, the pulse width of the pulse I₆ is compared with the average pulse width of the remainder of the pulses, it becomes clear that the pulse I₆ is an additional pulse within a pulse gap between adjacent pulses I₆ and I₇.

In the instance of application shown in FIG. 4, it is sensed that the test period t₅ is very much greater than the adjacent signal periods t₄ and t₆. By additionally taking into account the sensed width of the pulse I₅, the method described is used to easily establish that this involves an absent pulse gap.

In the instance of application 5, the signal periods t₄ to t₆ are used to sense a test period t₅ that is much too short in proportion. By additionally taking into account the respective pulse width, it is a simple matter to use the method described above to establish that there is an additional pulse gap within a pulse in this case.

By ascertaining the incorrect or erroneous pulses and the absent pulses as described above, precise speed sensing is made possible.

What is claimed is:

1. A method for operating a speed sensing device including a magnetically operating speed encoder located on a rotatably mounted shaft and a fixed sensor configured to interact with the speed encoder, the method comprising:
producing a plurality of electrical pulses, each electrical pulse of the plurality of electrical pulses being produced in response to at least one encoder element of the speed encoder moving past the fixed sensor upon a revolution of the rotatably mounted shaft;
sensing the plurality of electrical pulses to determine a speed of the rotatably mounted shaft;
measuring and storing a plurality of respective times for at least a plurality of successive electrical pulses of the plurality of electrical pulses, each respective time of the plurality of respective times being a duration of a signal period, of a plurality of signal periods, between at least two successive electrical pulses of the plurality of successive electrical pulses; and
comparing a respective time of the plurality of respective times of at least one selected test period of the plurality of signal periods with (i) a previous respective time of the plurality of respective times of a previous signal period of the plurality of signal periods, and (ii) with a subsequent respective time of the plurality of respective times of a subsequent signal period of the plurality of signal periods in order to detect at least one of absent electrical pulse of the plurality of electrical pulses, and incorrect electrical pulses of the plurality of electrical pulses.

2. The method according to claim 1, wherein one of the absent electrical pulses is sensed when the respective time of the at least one selected test period is greater than the previous respective time and the subsequent respective time.

3. The method according to claim 1, wherein one of the incorrect electrical pulses is sensed when the respective time of the at least one selected test period is less than the previous respective time or the subsequent respective time.

4. The method according to claim 1, wherein one of the incorrect electrical pulses is sensed when the respective time of the at least one selected test period is at least half as short as the previous respective time or the subsequent respective time.

5. The method according to claim 1, further comprising:
measuring and storing a pulse width of the at least a plurality of successive electrical pulses.

6. The method according to claim 5, wherein one of the absent electrical pulses is detected based on an average width of the pulse widths.

7. The method according to claim 5, wherein an incorrect electrical pulse is detected when the pulse width of a sensed electrical pulse is within a prescribable period of time.

8. A speed sensing apparatus, comprising:
a magnetically operating speed encoder located on a rotatable shaft and including at least one encoder element;
a fixed sensor configured to interact with the speed encoder, the at least one encoder element being configured to move past the fixed sensor upon a revolution of the rotatable shaft to produce an electrical pulse; and
a control unit configured (i) to sense the electrical pulses produced, and (ii) to determine a speed of the rotating shaft based on a plurality of electrical pulses of the sensed electrical pulses,
wherein the control unit is further configured to carry out a method for operating the speed sensing apparatus, and
wherein the method includes
measuring and storing a plurality of respective times for at least a plurality of successive electrical pulses of the plurality of electrical pulses, each respective time of the plurality of respective times being a duration of a signal period, of a plurality of signal periods, between at least two successive electrical pulses of the plurality of successive electrical pulses, and
comparing a respective time of the plurality of respective times of at least one selected test period of the plurality of signal periods with (i) a previous respective time of the plurality of respective times of a previous signal period of the plurality of signal periods, and (ii) with a subsequent respective time of the plurality of respective times of a subsequent signal period of the plurality of signal periods in order to detect at least one of absent electrical pulse of the plurality of electrical pulses, and incorrect electrical pulses of the plurality of electrical pulses.
